(19) United States
(12) Patent Application Publication
(10) Pub. No.: US 2014/0143768 A1
(43) Pub. Date: May 22, 2014

(54) MONITORING UPDATES ON MULTIPLE COMPUTING PLATFORMS

(71) Applicant: INTERNATIONAL BUSINESS MACHINES CORPORATION, Armonk, NY (US)

(72) Inventors: Tomasz Kazalski, Krakow (PL); Rafael L. Perez, Singapore (SG); Hari H. Madduri, Austin, TX (US); Tomasz Sekman, Krakow (PL); Milosz Tucholewski, Krakow (PL)

(73) Assignee: International Business Machines Corporation, Armonk, NY (US)

(21) Appl. No.: 13/680,207

(22) Filed: Nov. 19, 2012

(51) Int. Cl. G06F 9/445

(52) U.S. Cl. 717/171

(57) ABSTRACT

According to one aspect of the present disclosure, a method and technique for monitoring updates on multiple computing platforms is disclosed. The method includes: initiating an update to a plurality of computing platforms; analyzing tracking data corresponding to each of the plurality of computing platforms indicating an installation progress of the update; dynamically calculating a timeout period for an installation of the update based on the tracking data; and displaying the installation progress for each of the plurality of computing platforms relative to the timeout period.

### BACKGROUND

A typical computing appliance may include multiple blade servers or computing platform devices (e.g., located in a rack-mounted chassis). Each computing platform of the appliance may include a number of different hardware components each including firmware for controlling the function/operation of such hardware component (e.g., network switches, management modules, disks, etc.). In some instances, the firmware may need to be updated/modified to correct defects, improve functionality, and/or add features/functionality. Generally, to update the firmware for the appliance, the firmware is updated for each (or certain ones) of the computing platform devices. During this process, the appliance is generally taken offline and rebooted utilizing a firmware update installation program to execute/install the needed firmware updates on the designated blade servers/computing platforms.

### BRIEF SUMMARY

According to one aspect of the present disclosure a method and technique for monitoring updates on multiple computing platforms is disclosed. The method includes: initiating an update to a plurality of computing platforms; analyzing tracking data corresponding to each of the plurality of computing platforms indicating an installation progress of the update; dynamically calculating a timeout period for an installation of the update based on the tracking data; and displaying the installation progress for each of the plurality of computing platforms relative to the timeout period.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of a network of data processing systems in which the illustrative embodiments of the present disclosure may be implemented;

FIG. 2 is an embodiment of a data processing system in which the illustrative embodiments of the present disclosure may be implemented;

FIG. 3 is a diagram illustrating an embodiment of a data processing system for monitoring updates on multiple computing platforms in which illustrative embodiments of the present disclosure may be implemented; and

FIG. 4 is a flow diagram illustrating an embodiment of a method for monitoring updates on multiple computing platforms according to the present disclosure.

### DETAILED DESCRIPTION

Embodiments of the present disclosure provide a method and technique for monitoring updates across multiple computing platforms and detecting delays or failures in the update installation. For example, in some embodiments, the method and technique includes: initiating an update to a plurality of computing platforms; analyzing tracking data corresponding to each of the plurality of computing platforms indicating an installation progress of the update; dynamically calculating a timeout period for an installation of the update based on the tracking data; and displaying the installation progress for each of the plurality of computing platforms relative to the timeout period. Embodiments of the present disclosure enable the monitoring of updates to a plurality of computing platforms (e.g., a plurality of blade servers of chassis or appliance) and to detect errors or problems with the update based on the behavior of particular computing platforms relative to other computing platforms that are also installing the designated update. Embodiments of the present disclosure utilize current progress and/or installation behavior information for the monitored computing platforms to dynamically calculate the average or expected time required to execute/install the update, determine whether certain computing platforms are exceeding the average/expected completion time as compared to other computing platforms, determine whether those computing platforms exceeding the average or expected time required to execute/install the update have exceeded an acceptable delay beyond the average or expected time required to execute/install the update, and indicate the status of such computing platforms to enable a desired and/or corrective action to be initiated.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

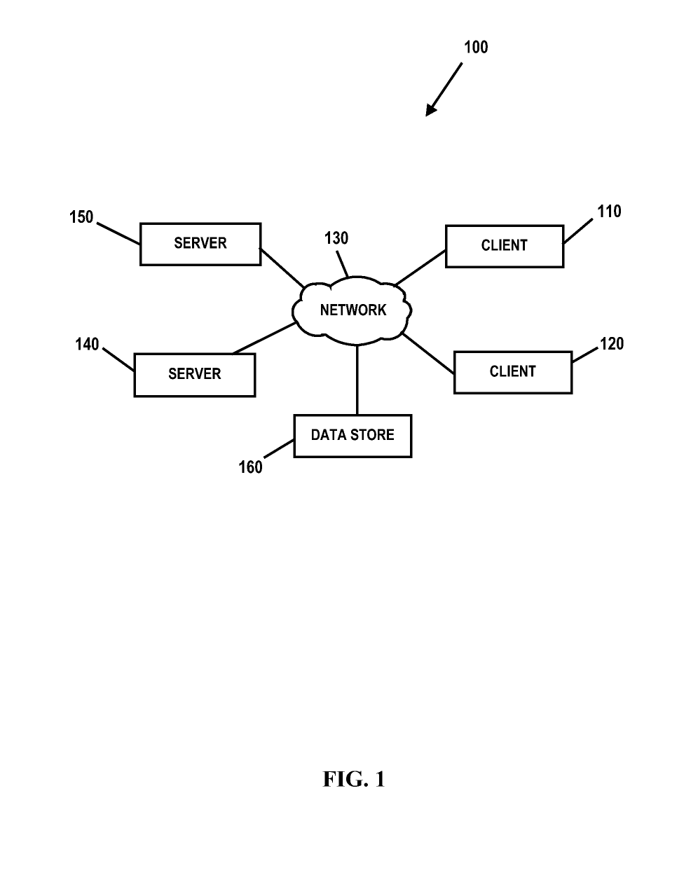

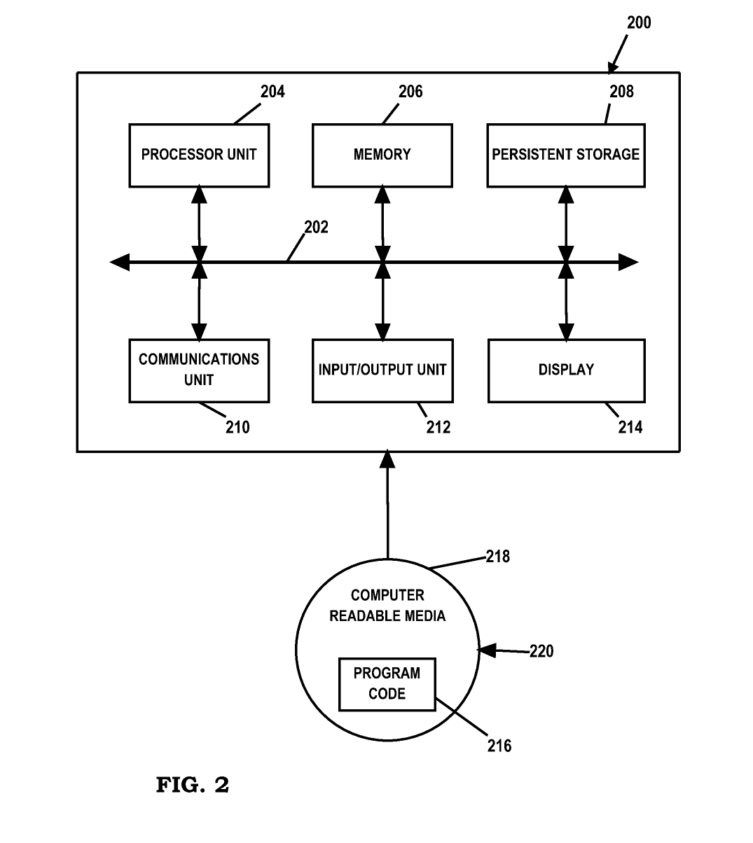

With reference now to the Figures and in particular with reference to FIGS. 1-2, exemplary diagrams of data processing environments are provided in which illustrative embodiments of the present disclosure may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments of the present disclosure may be implemented. Network data processing system 100 is a network of computers in which the illustrative embodiments of the present disclosure may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, server 140 and server 150 connect to network 130 along with data store 160. Server 140 and server 150 may be, for example, IBM System p® servers. In addition, clients 110 and 120 connect to network 130. Clients 110 and 120 may be, for example, personal computers or network computers. In the depicted example, server 140 provides data and/or services such as, but not limited to, data files, operating system images, and applications to clients 110 and 120. Network data processing system 100 may include additional servers, clients, and other devices.

In the depicted example, network data processing system 100 is the Internet with network 130 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system 200 such as, but not limited to, client 110 and/or server 140 in which an embodiment of a system for monitoring updates across multiple computing platforms according to the present disclosure may be implemented. In this embodiment, data processing system 200 includes a bus or communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

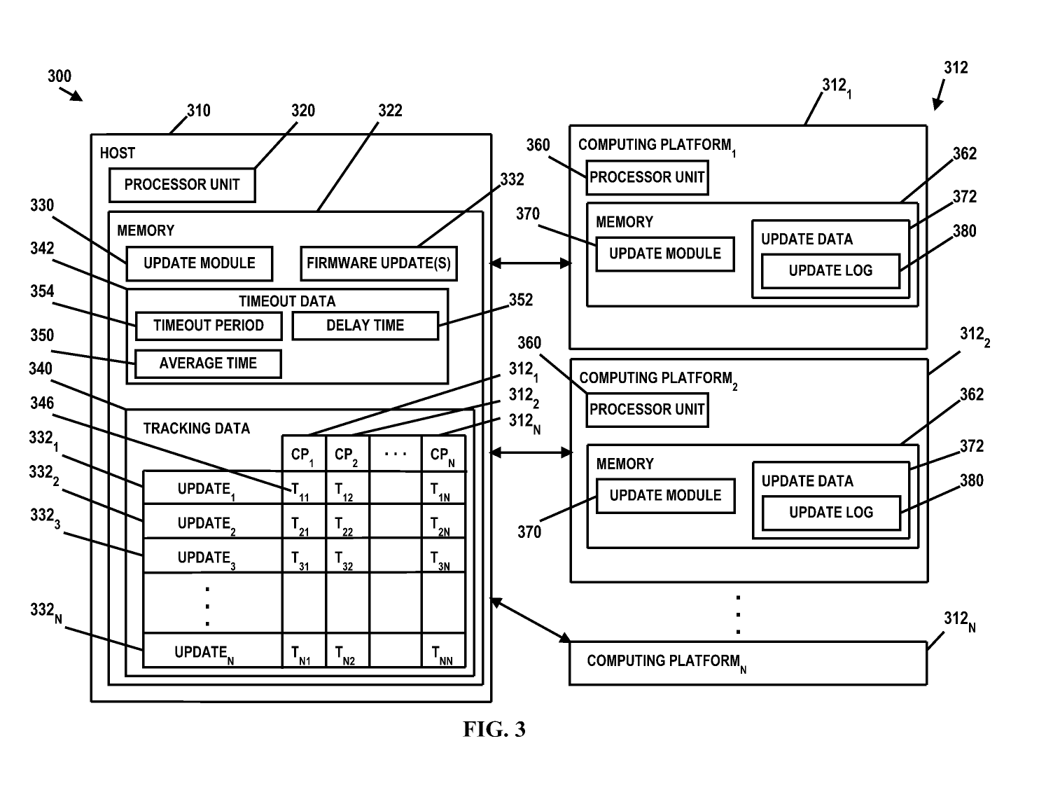

FIG. 3 is an illustrative embodiment of a system 300 for monitoring updates across multiple computing platforms. System 300 may be implemented on data processing systems or platforms such as, but not limited to, servers 140 and/or 150, clients 110 and/or 120, or at other data processing system locations. In the embodiment illustrated in FIG. 3, system 300 is illustrated and described in connection with a firmware update; however, it should be understood that system 300 may be utilized for other types of data updates (e.g., software/code or non-code information such as, but not limited to, data updates to information databases). In FIG. 3, system 300 includes a host 310 and a plurality of computing platforms 312 (identified as computing platforms 312₁-312ₙ in FIG. 3). Host 310 may comprise a data processing system or platform such as, but not limited to, servers 140 and/or 150. Computing platforms 312 may also comprise data processing systems or platforms such as, but not limited to, servers 140 and/or 150 (e.g., blade servers located in a rack-mounted chassis) or any other type of computing appliance that may include hardware and software logic (e.g., video cameras, global positioning system (GPS) devices, information technology (IT) appliances, surveillance devices, etc.). In the illustrated embodiment, host 310 is configured to implement and/or otherwise install (or cause to be installed) one or more firmware updates to various hardware components of computing platforms 312. For example, the firmware update may be related to network switches, disks, management modules, and/or any other type of hardware component associated with computing platforms 312.

In the illustrated embodiment, host 310 comprises one or more processor units 320 and a memory 322. In FIG. 3, memory 322 includes an update module 330, one or more firmware updates 332, tracking data 340 and timeout data 342. Firmware update(s) 332 comprises code, drivers and/or other types of logic for updating, modifying and/or otherwise altering the firmware of a corresponding computing platform hardware device or component. Update module 330 is configured to initiate, control and/or monitor the implementation and/or installation of a particular firmware update 332 to computing platforms 312. For example, update module 330 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system). In some embodiments, update module 330 is configured to collect information corresponding to the progress and/or completed installation of firmware updates 332 for respective computing platforms 312, dynamically derive an average successful execution/completion time for a particular firmware update 332, dynamically determine an acceptable delay time period for executing/completing the installation of a particular firmware update 332, and/or display (or otherwise output) status information related to the execution/completion of the firmware updates 332 for the respective computing platforms 312. In some embodiments, update module 330 may be configured to interrupt the installation process of a firmware update 332 for a particular computing platform 312 if the installation of the particular firmware update 332 exceeds a timeout period. The interruption of the installation of the firmware update 332 for a particular computing platform 312 may be user-initiated and/or automatic (i.e., without user intervention).

Tracking data 340 may comprise information associated with the execution/installation of each firmware update 332 for each respective computing platform 312. For example, in the illustrated embodiment, tracking data 340 may comprise a time period 346 (represented by “T” reference variables in FIG. 3) or other type of information associated with the current progress and/or completion for a particular firmware update 332 on a particular computing platform 312. For example, in FIG. 3, for each firmware update 332₁ through 332ₙ, tracking data 340 comprises information corresponding to the progress and/or successful completion on a respective computing platform 312₁ through 312ₙ (e.g., T₁₁ representing tracking data for firmware update 332₁ on computing platform 312₁, T₁₂ representing tracking data for firmware update 332₁ on computing platform 312₂, etc.). Based on the information collected and/or derived as tracking data 340, update module 330 may dynamically derive an average successful execution time for a particular firmware update 332, determine which computing platforms 312 have successfully completed the installation/execution of a particular firmware update 332, dynamically determine an acceptable delay time period associated with the completion of a particular firmware update 332 (e.g., an acceptable time period beyond the average or expected completion time), and identify which computing platforms 312 may have experienced a potential error, irregularity or other type of problem associated with the installation/execution of a particular firmware update 332. Thus, timeout data 342 may comprise an average successful execution time 350 for each particular firmware update 332, an acceptable delay time period 352 for the completion of a particular firmware update 332 (e.g., an acceptable time period beyond the average or expected completion time), and a timeout period 354 (e.g., a time period considered to represent the maximum amount of time to allocate to the execution/completion of a particular firmware update 332 before indicating a potential problem with the execution/installation of the respective firmware update 332 (e.g., average time 350 plus the acceptable delay period 352)). As an example of the foregoing, consider the following equations/formulas:

TP=AET*ET

and

ET=1.1+(0.2−(FCP/TCP*0.2)

where “TP” represents the timeout period 354, “AET” represents the average successful execution time 350 for a particular firmware update 332 (dynamically calculated based on those computing platforms 312 finishing/completing the execution/installation of the particular firmware update 332), “ET” represents the amount of extra time or acceptable delay time period 352, “FCP” represents a quantity of computing platforms 312 which have finished execution/installation of the particular firmware update 332, and “TCP” represents the total quantity of computing platforms 312 selected to install/execute the particular firmware update 332. In the above example, the acceptable delay ET (or extra time beyond the average execution time) is set to be a 10-30% margin which will dynamically decrease based on the quantity of computing platforms 312 finishing the execution/installation of the particular firmware update 332. Thus, in some embodiments, the average successful execution time 350, acceptable delay time period 352, and timeout period 354 to be used for and/or applied to a particular firmware update 332 is dynamically determined (e.g., in real time or near real time) based on the progress and/or completion of the execution/installation of the particular firmware update 332. It should be understood that other equations, formulas, or methods may be used to calculate acceptable delay time period 352 for the completion of a particular firmware update 332 and/or timeout period 354.

In the embodiment illustrated in FIG. 3, for ease of description and illustration, each computing platform 312 is depicted as being similarly configured; however, it should be understood that in some embodiments, certain computing platforms 312 may be differently configured. For example, although computing platforms 312 may be configured differently (e.g., containing different hardware/software/firmware/etc.), the differences may not impact (or may negligibly impact) the behavior of the respective computing platforms 312 for update execution/completion. In FIG. 3, each computing platform 312 includes one or more processor units 360 and a memory 362. Memory 362 comprises an update module 370 and update data 372. In some embodiments, update module 370 is configured to monitor and/or record information associated with one or more firmware updates 332 to be implemented by the respective computing platform 312. Update module 370 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system). Update data 372 may comprise various types of information associated with the progress of execution/installation of a particular firmware update 332. For example, in some embodiments, update data 372 may comprise an update log 380 containing log files generated by update module 370 as update module 370 tracks and/or monitors the execution/installation of a particular firmware update 332. In some embodiments, update module 370 may be configured to periodically communicate update data 372 to host 310 to enable update module 330 of host 310 to analyze update data 372 and/or generate/derive tracking data 340. In some embodiments, update module 330 of host 310 may be configured to periodically poll update modules 370 of computing platforms 312 to obtain update data 372. In other embodiments, update module 370 may be configured to transmit update data 372 to host 310 in response to a change in update data 372 (e.g., in response to a change in a log file from a previous check or a new log file).

Thus, in operation, update module 330 may be used to initiate the execution/installation of one or more firmware updates 332 on computing platforms 312. Generally, installing a firmware update may require that each computing platform be booted with a special bootable media which supports and contains code or a firmware update installation program. The progress of the firmware update 332 may be monitored by update module 330 for each computing platform 312 by, for example, log file examination based on update data 372 generated by each respective computing platform 312. In some embodiments, multiple firmware updates 332 may be executed (e.g., one for each component installed on a particular computing platform 312). These firmware updates 332 may be executed in the same order on each of the computing platforms 312. For similar computing platforms 312, the execution times for a particular firmware update 332 should be similar, thereby enabling update module 330 to compare tracking data 340 for each computing platform 312 and detect problems or error conditions (e.g., by comparing execution times of the particular firmware update 332 across respective computing platforms 312, including with respect to computing platforms 312 that have successfully executed the particular firmware update 332). In some embodiments, update module 330 may be configured to display and/or otherwise indicate to a user/administrator the progress of the firmware update 332 by indicating how many firmware updates 332 have been applied so far and how many firmware updates 332 need to be applied in total. Update module 330 may also indicate if delays have been detected regarding a particular computing platform 312 and/or firmware update 332. Based on this information, the user/administrator may interrupt the firmware update process for a particular computing platform 312 and proceed with diagnostic and recovery procedures regarding the interrupted computing platform 312 (e.g., avoiding any further maintenance window extension for the firmware update procedure). Thus, for example, if there are ninety-six computing platforms 312 and ninety-five of the computing platforms 312 have finished executing a particular firmware update 332 after an average time 350 of fifteen minutes, update module 330 may indicate the delayed status for the remaining computing platform 312 and enable the user/administrator to interrupt the update process for the remaining computing platform 312 (thereby enabling the ninety-five computing platforms 312 that have completed the firmware installation to be brought back online without having to wait for an extended amount of time which may otherwise occur while waiting for the process to complete with respect to all computing platforms 312). Additional and/or different actions may also be implemented in response to detecting a delay regarding a particular computing platform 312 and/or firmware update 332 (e.g., by a user/administrator and/or automatically by update module 330. For example, in some embodiments, in response to detecting a delay regarding a particular computing platform 312 and/or firmware update 332, an action may be taken to preemptively abort any other computing platforms 312 that have not completed that particular update 332 and isolate the respective computing platforms 312 as failed devices. In some embodiments, the acceptable delay time period 352 may be extended and/or switch to a different formula/method for determining the acceptable delay time period 352. Thus, it should be understood that a variety of types of remedial actions may be taken in response to a detecting a delay relative to a particular computing platform 312 and/or firmware update 332.

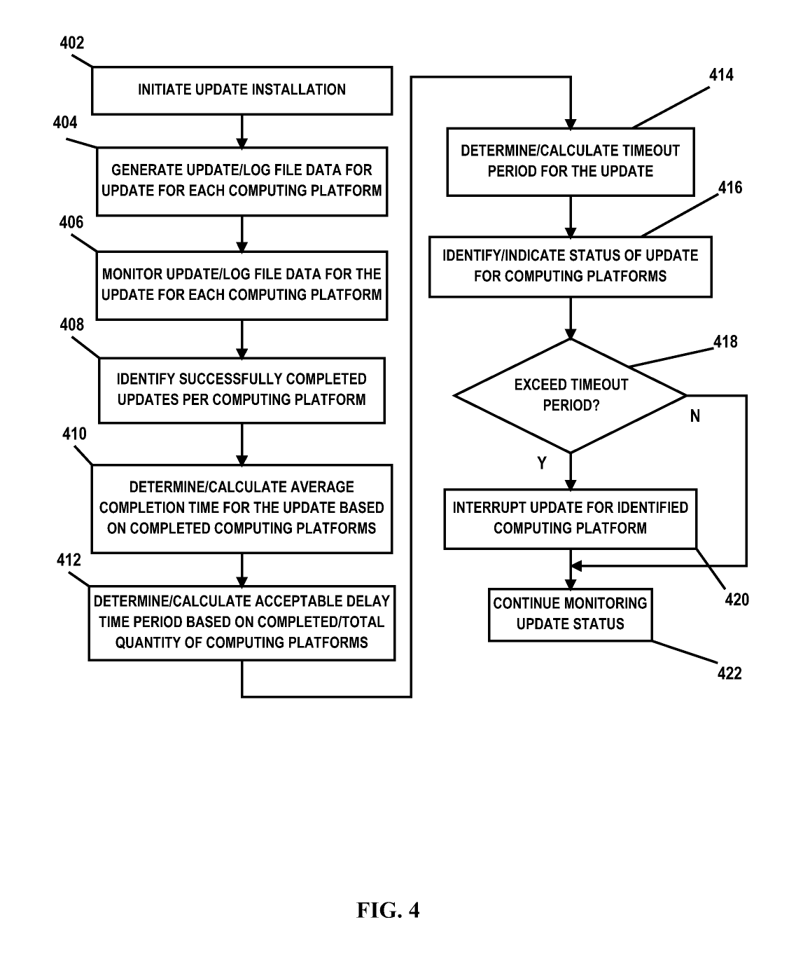

FIG. 4 is a flow diagram illustrating an embodiment of a method for monitoring updates across multiple computing platforms and detecting delays or failures in the update installation. The method begins at block 402, where an update installation process is initiated relative to a plurality of computing platforms 312. At block 404, update modules 370 of respective computing platforms 312 generate update data 372 (e.g., log files or other types of tracking information) indicating the progress of the execution/installation of the particular update on the respective computing platform 312. At block 406, update module 330 monitors the progress of the execution/installation of the update for respective computing platforms 312 by analyzing update data 372 generated by each respective computing platform 312. At block 408, update module 330 identifies computing platforms 312 that have successfully completed execution/installation of the update.

At block, 410, update module 330 determines and/or calculates the average time period 350 for update completion based on tracking data 340 corresponding to the computing platforms 312 having completed the execution/installation. At block 412, update module 330 determines and/or calculates the acceptable delay time period 352 for completion of the execution/installation of the update (e.g., based on a defined and/or predetermined (or variable) margin). At block 414, update module 330 determines and/or calculates a timeout period 354 for the particular update. At block 416, update module 330 identifies and/or otherwise indicates the status of update progress for the respective computing platforms 312. At decisional block 418, a determination is made whether any particular computing platforms 312 have yet to complete execution/installation of the update based on the determined timeout period 354. If not, the method proceeds to block 422. If at decisional block 418 it is determined that certain computing platforms 312 have yet to complete execution/installation of the update within the timeout period 354, the method proceeds to block 420, where the update process for the identified computing platforms 312 may be interrupted (e.g., automatically or by user/administrator intervention). At block 422, update module 330 continues monitoring the current and/or any remaining updates for the respective computing platforms 312.

Thus, embodiments of the present disclosure enable the monitoring of updates to a plurality of computing platforms and to detect errors or problems with the update based on the behavior of particular computing platforms relative to other computing platforms that are also installing the designated update. Embodiments of the present disclosure utilize current progress and/or installation behavior information for the monitored computing platforms to dynamically calculate the average or expected time required to execute/install the update, determine whether certain computing platforms are exceeding the average/expected completion time as compared to other computing platforms, determine whether those computing platforms exceeding the average or expected time required to execute/install the update have exceeded an acceptable delay beyond the average or expected time required to execute/install the update, and indicate the status of such computing platforms to enable a desired and/or corrective action to be initiated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method, comprising:
initiating an update to a plurality of computing platforms;
analyzing tracking data corresponding to each of the plurality of computing platforms indicating an installation progress of the update;
dynamically calculating a timeout period for an installation of the update based on the tracking data; and
displaying the installation progress for each of the plurality of computing platforms relative to the timeout period.

2. The method of claim 1, further comprising:
determining an average time period for successfully installing the update based on the tracking data; and
dynamically calculating an acceptable increase time period beyond the average time period for the installation of the update.

3. The method of claim 2, further comprising dynamically calculating the timeout period based on the average time period and the acceptable increase time period.

4. The method of claim 1, further comprising dynamically calculating the timeout period based on a quantity of computing platforms which have successfully finished the installation of the update and a total quantity of computing platforms attempting to install the update.

5. The method of claim 2, further comprising dynamically decreasing the acceptable increase time period based on a quantity of computing platforms that have finished installing the update.

6. The method of claim 1, further comprising interrupting the installation of the update for at least one of the computing platforms in response to the respective computing platform exceeding the timeout period.

7. The method of claim 1, further comprising:
monitoring an update log of each of the plurality of computing platforms associated with the installation of the update; and
responsive to a change in the update log by a respective computing platform, updating the tracking data for the respective computing platform.

8. A system, comprising:
a processor; and
an update module executable by the processor to manage installation of an update to a plurality of computing platforms, the update module operable to:
analyze tracking data corresponding to each of the plurality of computing platforms indicating an installation progress of the update;
dynamically calculate a timeout period for an installation of the update based on the tracking data; and
display the installation progress for each of the plurality of computing platforms relative to the timeout period.

9. The system of claim 8, wherein the update module is operable to:
determine an average time period for successfully installing the update based on the tracking data; and
dynamically calculate an acceptable increase time period beyond the average time period for the installation of the update.

10. The system of claim 9, wherein the update module is operable to dynamically calculate the timeout period based on the average time period and the acceptable increase time period.

11. The system of claim 8, wherein the update module is operable to dynamically calculate the timeout period based on a quantity of computing platforms which have successfully finished the installation of the update and a total quantity of computing platforms attempting to install the update.

12. The system of claim 9, wherein the update module is operable to dynamically decrease the acceptable increase time period based on a quantity of computing platforms that have finished installing the update.

13. The system of claim 8, wherein the update module is operable to interrupt the installation of the update for at least one of the computing platforms in response to the respective computing platform exceeding the timeout period.

14. A computer program product for monitoring update installation to a plurality of computing platforms, the computer program product comprising:
a computer readable storage medium having computer readable program code embodied therewith, the computer readable program code comprising computer readable program code configured to:
analyze tracking data corresponding to each of the plurality of computing platforms indicating an installation progress of the update;
dynamically calculate a timeout period for an installation of the update based on the tracking data; and
display the installation progress for each of the plurality of computing platforms relative to the timeout period.

15. The computer program product of claim 14, wherein the computer readable program code is configured to:
determine an average time period for successfully installing the update based on the tracking data; and
dynamically calculate an acceptable increase time period beyond the average time period for the installation of the update.

16. The computer program product of claim 15, wherein the computer readable program code is configured to dynamically calculate the timeout period based on the average time period and the acceptable increase time period.

17. The computer program product of claim 14, wherein the computer readable program code is configured to dynamically calculate the timeout period based on a quantity of computing platforms which have successfully finished the installation of the update and a total quantity of computing platforms attempting to install the update.

18. The computer program product of claim 15, wherein the computer readable program code is configured to dynamically decrease the acceptable increase time period based on a quantity of computing platforms that have finished installing the update.

19. The computer program product of claim 14, wherein the computer readable program code is configured to interrupt the installation of the firmware update for at least one of the computing platforms in response to the respective computing platform exceeding the timeout period and initiate a remedial action for the interrupted computing platforms.

20. The computer program product of claim 14, wherein the computer readable program code is configured to:
monitor an update log of each of the plurality of computing platforms associated with the installation of the update; and
responsive to a change in the update log by a respective computing platform, update the tracking data for the respective computing platform.
